(19) United States
(12) Patent Application Publication
(10) Pub. No.: US 2026/0196734 A1
(43) Pub. Date: Jul. 9, 2026

(54) CAVITY ANTENNA, ANTENNA MODULE AND ELECTRONIC DEVICE

(71) Applicant: WNC Corporation, Hsinchu (TW)

(72) Inventors: Yu Fu KUO, Hsinchu (TW); Jing Jing GONG, Hsinchu (TW); Che Min LIN, Hsinchu (TW); Pingping PU, Hsinchu (TW); Hsiao Chan CHANG, Hsinchu (TW)

(21) Appl. No.: 19/258,991

(22) Filed: Jul. 3, 2025

(30) Foreign Application Priority Data
Jan. 8, 2025 (CN) 202510029493.X

(51) Int. Cl. H01Q 13/18; H01Q 1/22

(52) U.S. Cl. CPC H01Q 13/18; H01Q 1/2266

(57) ABSTRACT

A cavity antenna is made of a metal material and includes an antenna opening, a bottom portion and four side portions. The bottom portion is disposed opposite to the antenna opening, and the bottom portion is in a rectangular shape and includes four bottom edges. The four side portions are connected to the four bottom edges, respectively, and the four side portions are connected in sequence to form the cavity antenna being groove-shaped. One of the four side portions is a first side portion, which includes a concave section and a convex section. A concave edge of the concave section is coupled with a convex edge of the convex section to form the first side portion.

### RELATED APPLICATIONS

This application claims the benefit of priority to China Patent Application No. 202510029493.X, filed on Jan. 8, 2025. The entire content of the above identified application is incorporated herein by reference.

### BACKGROUND

### Technical Field

The present disclosure relates to a cavity antenna, an antenna module, and an electronic device, in particularly to a cavity antenna including an antenna opening, as well as an antenna module and an electronic device including the cavity antenna.

### Description of Related Art

With the advancement of technology, people are placing increasingly higher demands on the functional features and aesthetic appearance of electronic devices, thereby increasing the cost and complexity of development.

In the conventional product, antennas in electronic devices may be manufactured using plastic metallization or a combination of plastic and metal. However, the presence of a plastic layer limits the usable space inside the electronic device due to plastic molding constraints, reducing its available space. Alternatively, the electronic device may adopt a cavity antenna. However, cavity antennas fabricated by metal drawing have numerous manufacturing limitations and require high production costs. Moreover, additional post-processing such as welding or riveting is needed to add structural features, thereby making the overall fabrication process more complex and costly.

In view of the above, there is an urgent need in today's market for a cavity antenna, antenna module, and electronic device that can reduce costs and manufacturing complexity.

### SUMMARY

According to one aspect of the present disclosure, a cavity antenna made of a metal material is provided. The cavity antenna includes an antenna opening, a bottom portion, and four side portions. The bottom portion is disposed opposite to the antenna opening, is rectangular in shape, and includes four bottom edges. The four side portions are respectively connected to the four bottom edges and are sequentially connected to form the cavity antenna being groove-shaped. One of the four side portions is a first side portion, which includes a concave section and a convex section. A concave edge of the concave section is coupled with a convex edge of the convex section to form the first side portion.

According to another aspect of the present disclosure, an antenna module is provided, including a cavity antenna and a circuit board. The cavity antenna is made of a metal material and includes an antenna opening, a bottom portion, and four side portions. The bottom portion is disposed opposite to the antenna opening, is rectangular in shape, and includes four bottom edges. Each of the four side portions includes a closed edge and an opening edge, with the closed edge and the opening edge being disposed opposite to each other. The four closed edges are respectively connected to the four bottom edges, and the four side portions are sequentially connected to form the cavity antenna being groove-shaped, with the four opening edges disposed adjacent to the antenna opening. The circuit board is connected to at least one of the four opening edges and closes at least a portion of the antenna opening. One of the four side portions is a first side portion, which includes a concave section and a convex section. A concave edge of the concave section is coupled with a convex edge of the convex section to form the first side portion.

According to yet another aspect of the present disclosure, an electronic device is provided, including a cavity antenna and a housing. The cavity antenna is made of a metal material and includes an antenna opening, a bottom portion, and four side portions. The bottom portion is disposed opposite to the antenna opening, is rectangular in shape, and includes four bottom edges. Each of the four side portions includes a closed edge and an opening edge, which are disposed opposite to each other. The four closed edges are respectively connected to the four bottom edges, and the four side portions are sequentially connected to form the cavity antenna being groove-shaped, with the four opening edges adjacent to the antenna opening. The cavity antenna is disposed within the housing. One of the four side portions is a first side portion, which includes a concave section and a convex section. A concave edge of the concave section is coupled with a convex edge of the convex section to form the first side portion.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional view of a cavity antenna of an antenna module according to a first embodiment of the present disclosure.

FIG. 1B is a three-dimensional view of an original metal sheet of the cavity antenna shown in FIG. 1A.

FIG. 1C is a schematic view showing a sheet metal processing of the original metal sheet of the cavity antenna shown in FIG. 1B.

FIG. 1D is an exploded view of the antenna module according to the first embodiment.

FIG. 1E is a three-dimensional view of the antenna module shown in FIG. 1D.

FIG. 1F is a cross-sectional view taken along section line 1F-1F in FIG. 1E.

FIG. 1G is a schematic diagram showing the S11 parameters of the antenna module according to the first embodiment.

FIG. 2A is an exploded view of an antenna module according to a second embodiment of the present disclosure.

FIG. 2B is a three-dimensional view of the antenna module shown in FIG. 2A.

FIG. 3A is an exploded view of an antenna module according to a third embodiment of the present disclosure.

FIG. 3B is a three-dimensional view of the antenna module shown in FIG. 3A.

FIG. 4A is a three-dimensional view of an electronic device according to a fourth embodiment of the present disclosure.

FIG. 4B is a schematic diagram of a housing opening of the electronic device shown in FIG. 4A.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

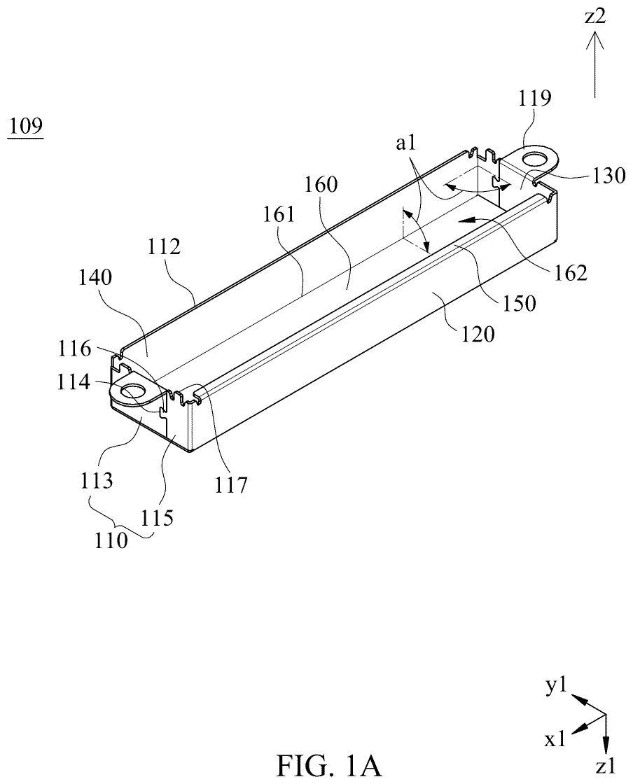

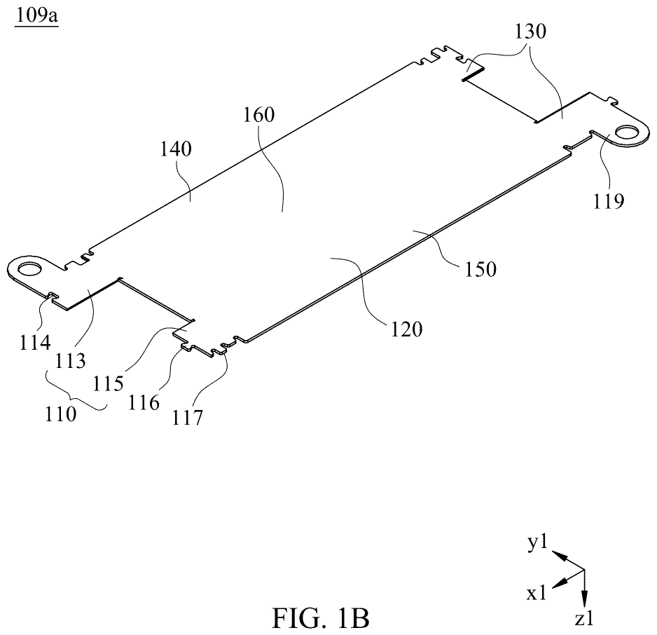

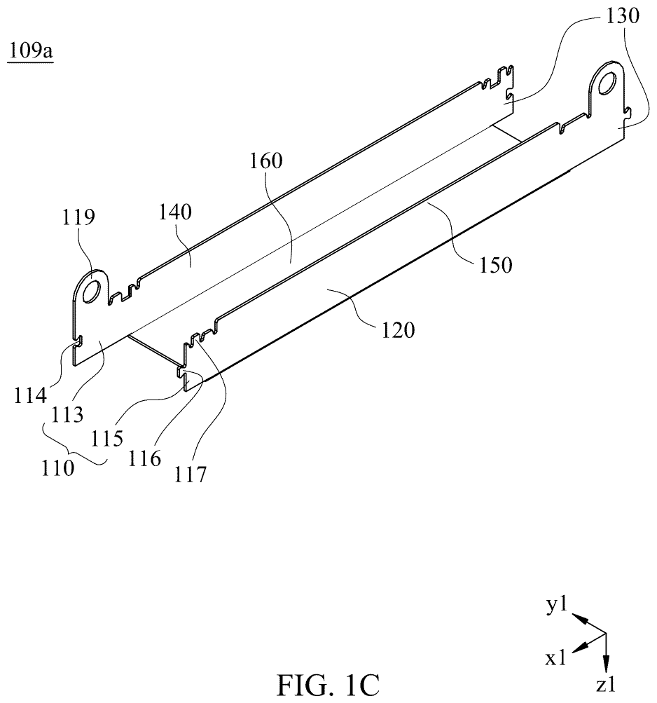

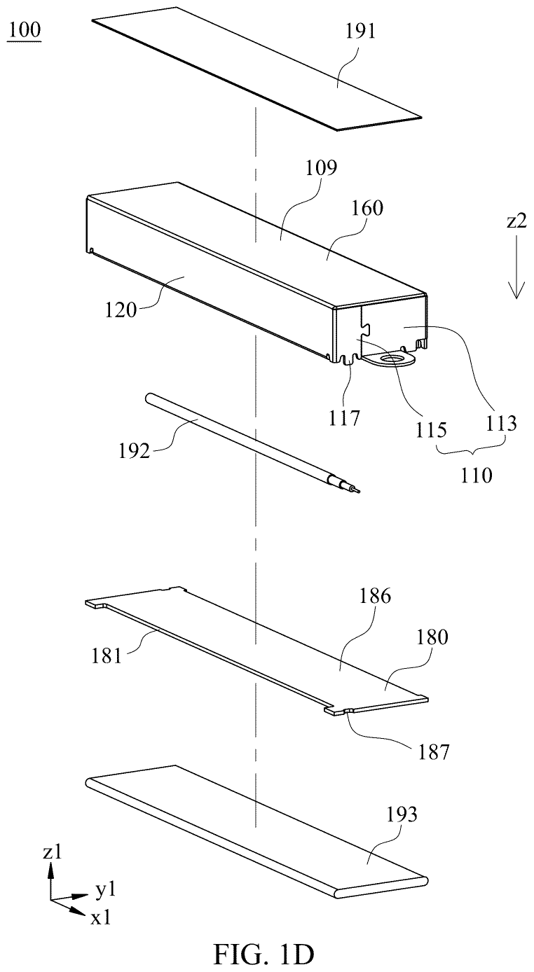

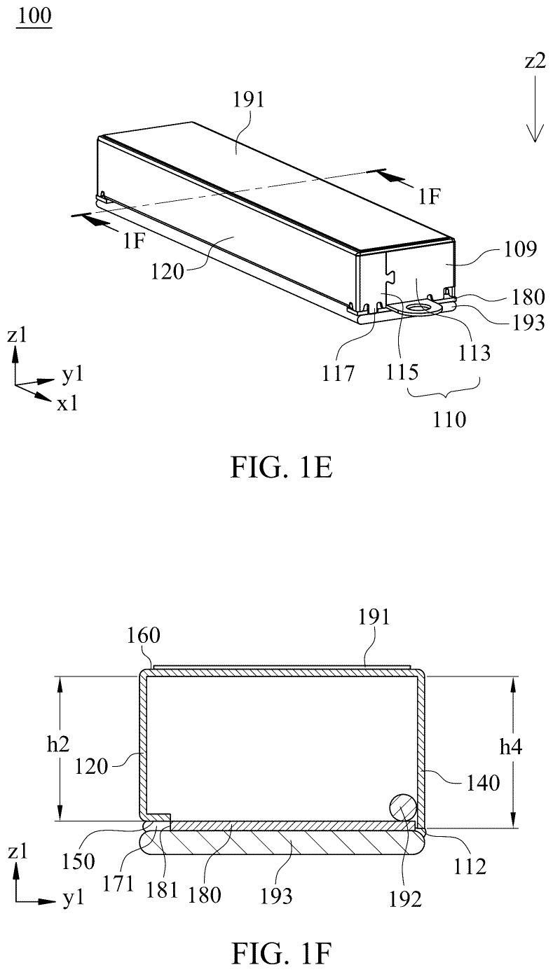

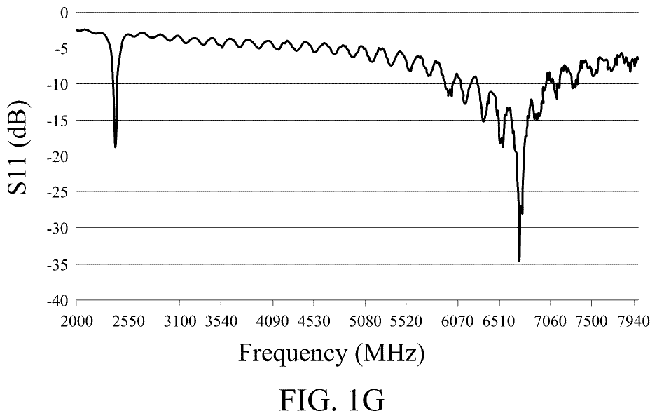

FIG. 1A is a three-dimensional view of a cavity antenna 109 of an antenna module 100 according to a first embodiment of the present disclosure. FIG. 1B is a three-dimensional view of an original metal sheet 109a of the cavity antenna 109 shown in FIG. 1A. FIG. 1C is a schematic view showing a sheet metal process of the original metal sheet 109a of the cavity antenna 109 shown in FIG. 1B. FIG. 1D is an exploded view of the antenna module 100 according to the first embodiment. FIG. 1E is a three-dimensional view of the antenna module 100 shown in FIG. 1D. Referring to FIGS. 1A through 1E, the antenna module 100 of the first embodiment according to the present disclosure includes the cavity antenna 109 and a circuit board 180. For clearer illustration, the present disclosure describes the drawings in terms of three mutually perpendicular directions: a first direction x1, a second direction y1, and a third direction z1.

Referring to FIG. 1A, the cavity antenna 109 is made of a metal material and includes an antenna opening 162, a bottom portion 160, and four side portions. Specifically, the four side portions are a first side portion 110, a second side portion 120, a third side portion 130, and a fourth side portion 140. The bottom portion 160 is disposed opposite to the antenna opening 162, has a rectangular shape, and includes four bottom edges 161. The first side portion 110, the second side portion 120, the third side portion 130, and the fourth side portion 140 are respectively connected to the four bottom edges 161 and sequentially connected to form the groove-shaped cavity antenna 109. One of first side portion 110, the second side portion 120, the third side portion 130, and the fourth side portion 140 is the first side portion 110, which includes a concave section 113 and a convex section 115. A concave edge 114 of the concave section 113 is coupled with a convex edge 116 of the convex section 115 to form the first side portion 110. Accordingly, compared to placing interlocking structures at the corners between adjacent side portions, using the concave edge 114 and convex edge 116 of the first side portion 110 as the interlocking structure helps enhance the sealing and strength characteristics of the cavity antenna 109, thereby improving its antenna performance.

Furthermore, each of the first side portion 110, the second side portion 120, the third side portion 130, and the fourth side portion 140 includes a closed edge (coinciding with the bottom edge 161, not separately labeled) and an opening edge 112. The closed edge and the opening edge 112 are disposed opposite to each other. The four closed edges are respectively connected to the four bottom edges 161, and the first side portion 110, the second side portion 120, the third side portion 130, and the fourth side portion 140 are sequentially connected to form a groove shape of the cavity antenna 109, with the four opening edges 112 disposed adjacent to the antenna opening 162.

Referring to FIGS. 1D and 1E, the circuit board 180 is connected to at least one of the four opening edges 112 of the cavity antenna 109 and closes at least a portion of the antenna opening 162. As such, the metal cavity of the cavity antenna 109, in combination with the circuitry on the circuit board 180, enables antenna resonance functionality. The internal volume, depth, and height of the cavity antenna 109 result in resonant characteristics corresponding to different frequency bands, thus satisfying multi-band antenna requirements. In the first embodiment, the bottom portion 160 of the cavity antenna 109 is disposed opposite to and parallel with the circuit board 180.

In detail, referring to FIGS. 1B and 1C, the cavity antenna 109 can be formed by sheet metal processing from an original metal sheet 109a. In contrast to conventional cavity antennas manufactured by metal drawing methods, which involve more limitations and higher costs, and require post-processing such as welding or riveting to add additional structures, the cavity antenna 109 disclosed herein is integrally formed from the original metal sheet 109a by sheet metal processing/bending, which helps reduce cost and manufacturing complexity, while enhancing design flexibility (e.g., the height or depth of the cavity antenna 109 is not limited). Specifically, the original metal sheet 109a may be made of nickel silver, phosphor bronze, or stainless steel. The cavity antenna 109 may be first bent into the intermediate form shown in FIG. 1C from the original metal sheet 109a shown in FIG. 1B, and then further bent into the integrally formed cavity antenna 109 shown in FIG. 1A. The material and bending process are not limited thereto, and additional structures formed by welding or riveting and protruding from or recessed into the plane defined by the first direction x1 and second direction y1 are not required.

Referring to FIG. 1A, the bottom portion 160 and at least one (specifically, each) of the first side portion 110, the second side portion 120, the third side portion 130, and the fourth side portion 140 may be formed by bending. A chamfer (rounded corner or R angle) a1 between the bottom portion 160 and each of the first side portion 110, the second side portion 120, the third side portion 130, and the fourth side portion 140 may range from 0.4T (i.e., the radius of the chamfer a1 is 0.4 times the thickness of the bottom portion 160) to 2T. A chamfer a1 between any connected/adjacent two of the first side portion 110, the second side portion 120, the third side portion 130, and the fourth side portion 140 may be formed by bending and may also range from 0.4T to 2T. In contrast, conventional cavity antennas made by metal drawing methods are typically limited in height to about 5 times to 10 times the metal plate thickness, and require relatively large chamfers (greater than 3T, depending on the material) to avoid cavity rupture. The cavity antenna 109 disclosed herein, being integrally formed by sheet metal processing/bending from the original metal sheet 109a, allows for increased internal cavity volume, can be shaped to fit mating components, and is not constrained by height or large chamfer requirements, thereby enhancing design flexibility and reducing cost.

The convex edge 116 of the cavity antenna 109 may be or may include a dovetail shape. This helps reduce the design and manufacturing complexity of the miniaturized cavity antenna 109, while maintaining good sealing performance. Furthermore, the concave edge 114 and convex edge 116 may optionally be subjected to welding or riveting processes to prevent edge flaring. The convex edge of the cavity antenna disclosed herein is not limited to a dovetail shape.

The third side portion 130 is disposed opposite to the first side portion 110 and may include another concave section (not separately labeled) and another convex section (not separately labeled). A concave edge of the another concave section is coupled with a convex edge of the another convex section to form the third side portion 130. As such, both the first side portion 110 and the third side portion 130, being oppositely arranged, are designed with interlocking concave and convex sections, which help simplify the sheet metal fabrication process of the cavity antenna 109 and maintain sealing performance.

At least one of the concave section 113 and convex section 115 of the first side portion 110 may include a positioning structure 117, which protrudes in the antenna opening direction z2. In the first embodiment, the antenna opening direction z2 corresponds to the direction from the closed edge to the opening edge 112 of each side portion, and is the negative direction of the third direction z1. The antenna opening direction z2 is also parallel to the normal direction of the circuit board 180. This positioning structure assists in aligning the cavity antenna 109 with other components (e.g., the circuit board 180, but not limited thereto) during assembly. Furthermore, the cavity antenna 109 may include at least one fastening structure 119 to fix it to other components during assembly. According to other embodiments of the present disclosure, the positioning structure may be located on any of the four side portions.

FIG. 1F is a cross-sectional view taken along section line 1F-1F in FIG. 1E. Referring to FIGS. 1A and 1F, the cavity antenna 109 may further include at least one folding portion 150, which is connected to at least one of the first side portion 110, the second side portion 120, the third side portion 130, or the fourth side portion 140. The at least one folding portion 150 is disposed opposite to the bottom portion 160. Accordingly, the cavity antenna 109 may include an inwardly or outwardly folded skirt portion forming the folding portion 150, serving as a soldering platform. This facilitates accommodation of the solder material 171 for assembly with the circuit board 180, and supports both hand soldering and hot bar soldering. In the first embodiment, the cavity antenna 109 includes one folding portion 150, which is connected and formed by inward folding from the opening edge 112 of the second side portion 120. The hole design on the circuit board 180 and the folding portion 150 define a space to accommodate the solder material 171 (as shown in FIG. 1F). With appropriate heating processes, this design enables internal soldering without requiring additional space on the circuit board 180, thus achieving efficient space utilization.

The area of the folding portion 150 may be between 0.01 times and 0.2 times the area of the bottom portion 160. This ratio helps achieve sufficient sealing of the metal cavity formed by the cavity antenna 109 and the circuit board 180, without increasing the design complexity of the antenna characteristics. Specifically, the width of the folding portion 150 along the second direction y1 is approximately 1 mm.

The first side portion 110, the second side portion 120, the third side portion 130, and the fourth side portion 140 have a maximum height (along the third direction z1) measured from the bottom portion 160. This maximum height may not be located at the part of the second side portion 120 connected to the folding portion 150. Specifically, the maximum height of the cavity antenna 109 is located at the positioning structure 117 (as shown in FIG. 1A). In FIG. 1F, the part of the second side portion 120 connected to the folding portion 150 has a height h2, and the fourth side portion 140 has a height h4, with the maximum height being greater than the height h4, and the height h4 being greater than h2. This facilitates the formation of a space for accommodating the solder material 171 through the hole design on the circuit board 180 and the folding portion 150. According to embodiments of the present disclosure, the circuit board may also be directly soldered to the folding portion without a through-hole design. In other words, the projected areas of the folding portion and the circuit board on the plane formed by the first direction x1 and second direction y1 may be non-overlapping or at least partially overlapping.

Referring to FIGS. 1E and 1F, the folding portion 150 is disposed opposite to the bottom portion 160 and may be parallel to the circuit board 180. The folding portion 150 can accommodate the solder material 171, which connects the folding portion 150 to a side surface 181 of the circuit board 180. This configuration provides stable sealing for the cavity antenna 109, contributes to the miniaturization of the antenna module 100, and enhances its reliability.

The side surface 181 of the circuit board 180 may include at least one of a metal edging region and a plated through-hole (PTH), wherein the plated through-hole is not a complete circumference, thereby exposing the metal. This configuration allows the corresponding side surface 181 of the circuit board 180 to include either the metal edging region or the plated through-hole, regardless of whether the soldering platform is the folding portion 150 or the fourth side portion 140. The added metal layer on the side surface 181 facilitates joining the cavity antenna 109 and the circuit board 180 through laser welding, hand soldering, or hot bar soldering.

Referring to FIGS. 1D through 1F, the antenna module 100 may further include a cable 192 that is electrically connected to a circuit surface 186 of the circuit board 180, which faces the bottom portion 160 of the cavity antenna 109. This allows the antenna module 100 to input and/or output signals via the cable 192, thereby providing design flexibility. Furthermore, at least one of the four side portions (specifically the third side portion 130, but not limited thereto) may include at least one opening for the cable 192 to pass through. According to the present disclosure, the feeding port of the antenna module may be located at a circuit trace on the circuit board or a terminal of the cable. In addition, the antenna module 100 of the first embodiment may further include an adhesive element 191 and a spacer 193 assembled with the cavity antenna 109 and the circuit board 180, enabling the antenna module 100 to be installed within an electronic device (e.g., the electronic device 400 in the fourth embodiment).

The opening edge 112 of the fourth side portion 140 may be connected to the side surface 181 of the circuit board 180, and the cable 192 may be disposed adjacent to the opening edge 112 of the fourth side portion 140 and extend parallel to the fourth side portion 140. This design allows the opening edge 112 of the fourth side portion 140 to be connected to the side surface 181 of the circuit board 180 when the spatial constraints around the cable 192 prevent the inclusion of a folding portion 150. Additionally, if space permits, a folding portion 150 may also be provided on the fourth side portion 140 adjacent to the cable 192.

The positioning structure 117 protrudes in the antenna opening direction z2 and may be coupled with a recessed portion 187 of the circuit board 180. This allows the positioning structure 117 to align with the recessed portion 187 (such as a cut-out or hole) of the circuit board 180 for assembly alignment purposes. Specifically, the height of the positioning structure 117 may be equal to the thickness of the circuit board 180 (as shown in FIGS. 1D and 1E), or greater than the thickness of the circuit board 180. The width of the positioning structure 117 may be equal to or greater than 1 mm.

FIG. 1G is a schematic diagram showing the S11 parameters of the antenna module 100 according to the first embodiment. Referring to FIG. 1G, the antenna module 100 can operate in frequency bands near 2.4 GHz and 6.7 GHZ.

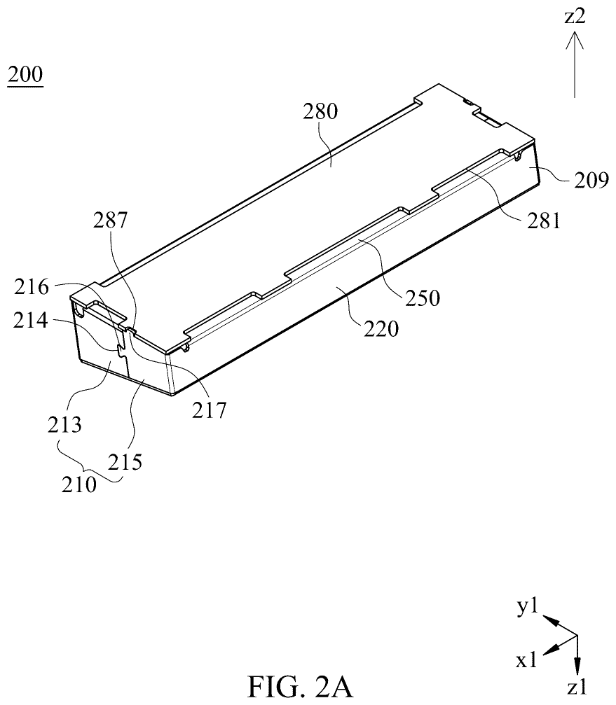

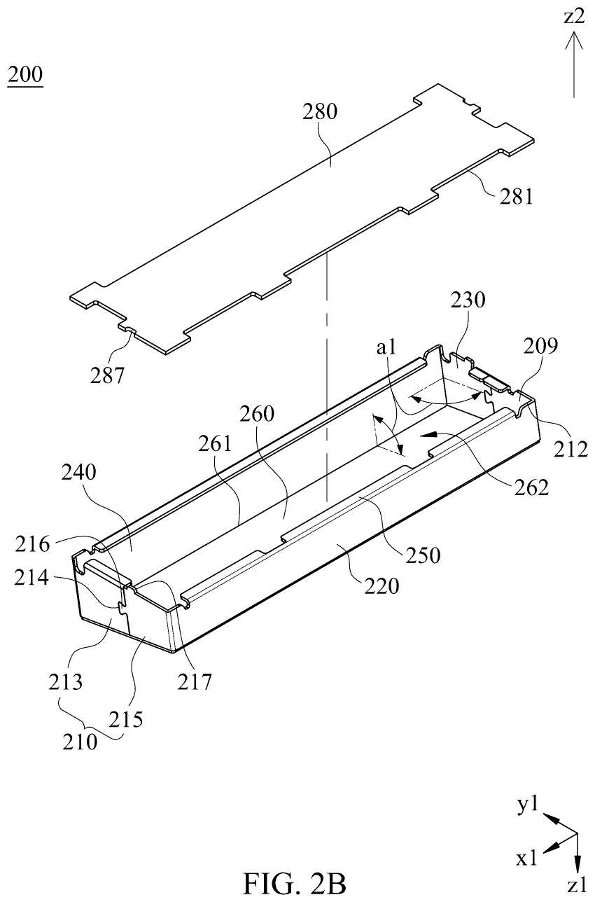

FIG. 2A is an exploded view of an antenna module 200 according to a second embodiment of the present disclosure, and FIG. 2B is a three-dimensional view of the antenna module 200 shown in FIG. 2A. Referring to FIGS. 2A and 2B, the antenna module 200 in the second embodiment includes a cavity antenna 209 and a circuit board 280.

The cavity antenna 209 is made of a metal material and includes an antenna opening 262, a bottom portion 260, a first side portion 210, a second side portion 220, a third side portion 230, and a fourth side portion 240. The bottom portion 260 is disposed opposite to the antenna opening 262, is rectangular in shape, and includes four bottom edges 261. The first side portion 210, the second side portion 220, the third side portion 230, and the fourth side portion 240 are respectively connected to the four bottom edges 261 and are sequentially connected to form the groove-shaped cavity antenna 209. The first side portion 210 includes a concave section 213 and a convex section 215. A concave edge 214 of the concave section 213 is coupled with a convex edge 216 of the convex section 215 to form the first side portion 210.

Furthermore, each of the first side portion 210, the second side portion 220, the third side portion 230, and the fourth side portion 240 includes a closed edge and an opening edge 212, which are disposed opposite to each other. The four closed edges are respectively connected to the four bottom edges 261, and the four opening edges 212 are located adjacent to the antenna opening 262. The circuit board 280 is connected to at least one of the four opening edges 212 and closes at least a portion of the antenna opening 262. In the second embodiment, the bottom portion 260 of the cavity antenna 209 is disposed opposite to but not parallel with the circuit board 280, and the heights of the first side portion 210 and third side portion 230 gradually decrease from the fourth side portion 240 toward the second side portion 220.

In detail, the cavity antenna 209 is formed by sheet metal processing of an original metal sheet. The bottom portion 260 and each of the first side portion 210, the second side portion 220, the third side portion 230, and the fourth side portion 240 are formed by bending, and the chamfer between the bottom portion 260 and each side portion may range between 0.4T and 2T. Similarly, a chamfer a1 between any two adjacent side portions formed by bending may also range from 0.4T to 2T. The convex edge 216 of the cavity antenna 209 has a dovetail shape. The third side portion 230, disposed opposite to the first side portion 210, includes another concave section and another convex section (not separately labeled). A concave edge of the another concave section is coupled with a convex edge of the another convex section to form the third side portion 230. The convex section 215 of the first side portion 210 includes a positioning structure 217, which protrudes in the antenna opening direction z2. In the second embodiment, the antenna opening direction z2 is defined as the direction from the closed edge to the opening edge 212 of each side portion and corresponds to the negative direction of the third direction z1. The antenna opening direction z2 is parallel to the normal direction of the circuit board 280.

The cavity antenna 209 further includes multiple folding portions 250. One of the folding portions 250 is connected to the concave section 213 of the first side portion 210, three of the folding portions 250 are connected to the second side portion 220, one of the folding portions 250 is connected to the convex section of the third side portion 230, one of the folding portions 250 is connected to the concave section of the third side portion 230, and one of the folding portions 250 is connected to the fourth side portion 240. Each folding portion 250 is disposed opposite to the bottom portion 260 and is formed by inward folding from the opening edge 212 of the corresponding side portion. The area of each of the folding portions 250 is between 0.01 times and 0.2 times the area of the bottom portion 260.

Furthermore, each of the folding portions 250 is disposed opposite to the bottom portion 260 and is parallel to the circuit board 280. The folding portions 250 accommodate solder material, which connects the folding portions 250 to a side surface 281 of the circuit board 280. The side surface 281 of the circuit board 280 includes at least one of a metal edging region and a plated through-hole. In addition, the positioning structure 217 protrudes in the antenna opening direction z2 and is coupled with a recessed portion 287 of the circuit board 280.

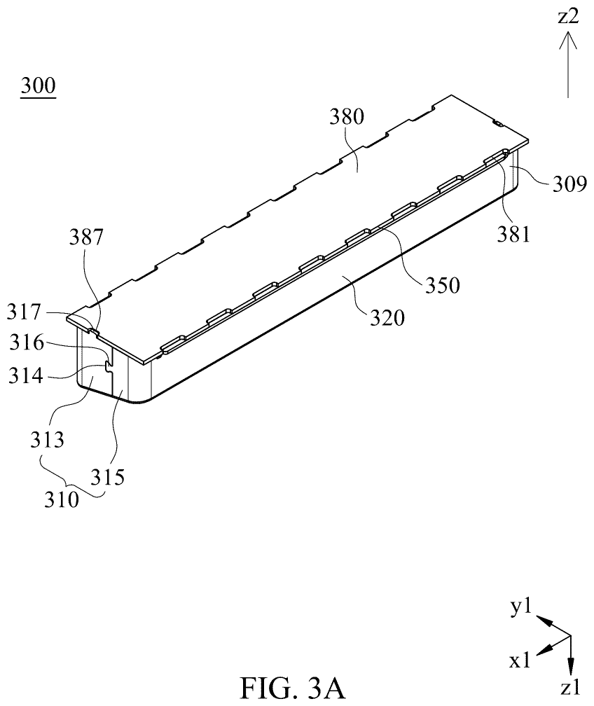

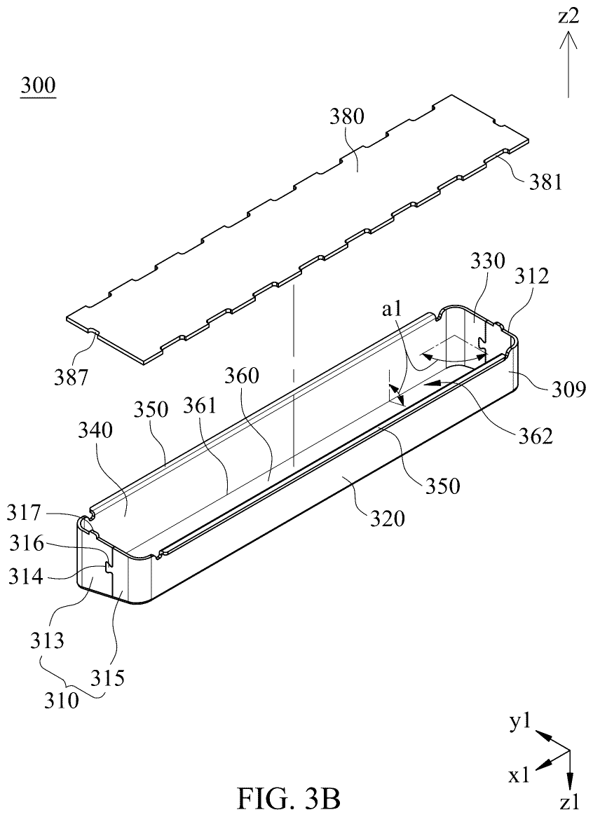

FIG. 3A is an exploded view of an antenna module 300 according to a third embodiment of the present disclosure, and FIG. 3B is a three-dimensional view of the antenna module 300 shown in FIG. 3A. Referring to FIGS. 3A and 3B, the antenna module 300 of the third embodiment according to the present disclosure includes a cavity antenna 309 and a circuit board 380. The cavity antenna 309 is made of a metal material and includes an antenna opening 362, a bottom portion 360, a first side portion 310, a second side portion 320, a third side portion 330, and a fourth side portion 340. The bottom portion 360 is disposed opposite to the antenna opening 362, has a rectangular shape, and includes four bottom edges 361. The first side portion 310, the second side portion 320, the third side portion 330, and the fourth side portion 340 are respectively connected to the four bottom edges 361 and sequentially connected to form the groove-shaped cavity antenna 309. The first side portion 310 includes a concave section 313 and a convex section 315. A concave edge 314 of the concave section 313 is coupled with a convex edge 316 of the convex section 315 to form the first side portion 310.

Furthermore, each of the first side portion 310, the second side portion 320, the third side portion 330, and the fourth side portion 340 includes a closed edge and an opening edge 312, which are arranged opposite to each other. The four closed edges are respectively connected to the four bottom edges 361, and the four opening edges 312 are located adjacent to the antenna opening 362. The circuit board 380 is connected to at least one of the four opening edges 312 and closes at least a portion of the antenna opening 362. In the third embodiment, the bottom portion 360 of the cavity antenna 309 is disposed opposite to, but not parallel with, the circuit board 380, and the heights of the first side portion 310 and the third side portion 330 gradually decrease from the fourth side portion 340 toward the second side portion 320.

In detail, the cavity antenna 309 is formed by sheet metal processing of an original metal sheet. The bottom portion 360 and each of the first side portion 310, the second side portion 320, the third side portion 330, and the fourth side portion 340 are formed by bending. The chamfer between the bottom portion 360 and each side portion is between 0.4T and 2T. The chamfer a1 between any two adjacent side portions formed by bending also ranges from 0.4T to 2T. The convex edge 316 of the cavity antenna 309 has a dovetail shape. The third side portion 330 is arranged opposite to the first side portion 310 and includes another concave section and another convex section (not separately labeled). A concave edge of the another concave section is coupled with a convex edge of the another convex section to form the third side portion 330. The convex section 315 of the first side portion 310 includes a positioning structure 317 that protrudes in the antenna opening direction z2. In the third embodiment, the antenna opening direction z2 is the direction from the closed edge to the opening edge 312 of each side portion, and corresponds to the negative direction of the third direction z1. The antenna opening direction z2 is parallel to the normal direction of the circuit board 380.

The cavity antenna 309 further includes two folding portions 350. One of the folding portions 350 is connected to the second side portion 320, and the other of the folding portions 350 is connected to the fourth side portion 340. Each of the folding portions 350 is disposed opposite to the bottom portion 360 and is formed by outward folding from the opening edge 312 of the connected side portion. The area of each of the folding portions 350 is between 0.01 times and 0.2 times the area of the bottom portion 360.

Furthermore, each of the folding portions 350 is disposed opposite to the bottom portion 360 and is parallel to the circuit board 380. The folding portion 350 accommodates solder material, which connects the folding portion 350 to a side surface 381 of the circuit board 380. The side surface 381 of the circuit board 380 includes at least one of a metal edging region and a plated through-hole. In addition, the positioning structure 317 protrudes in the antenna opening direction z2 and is coupled with a recessed portion 387 of the circuit board 380.

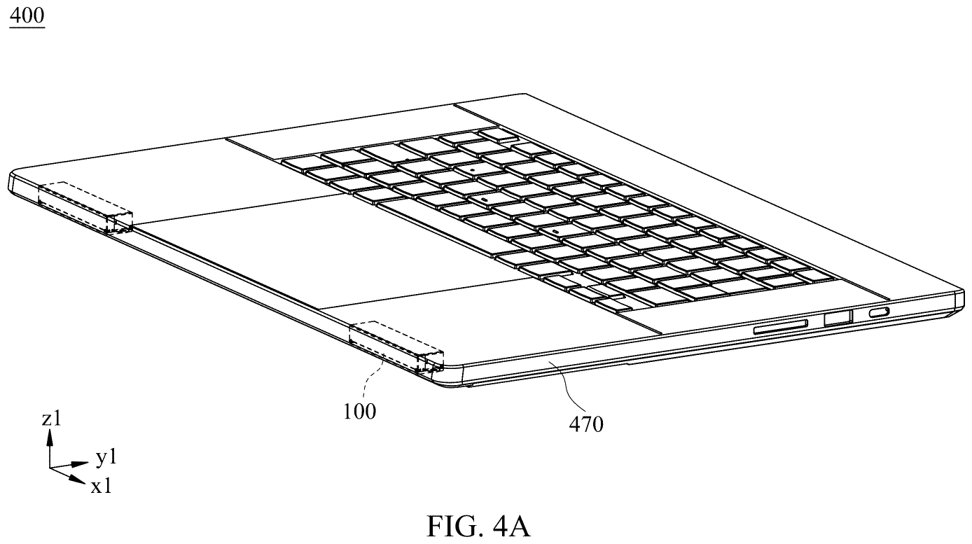

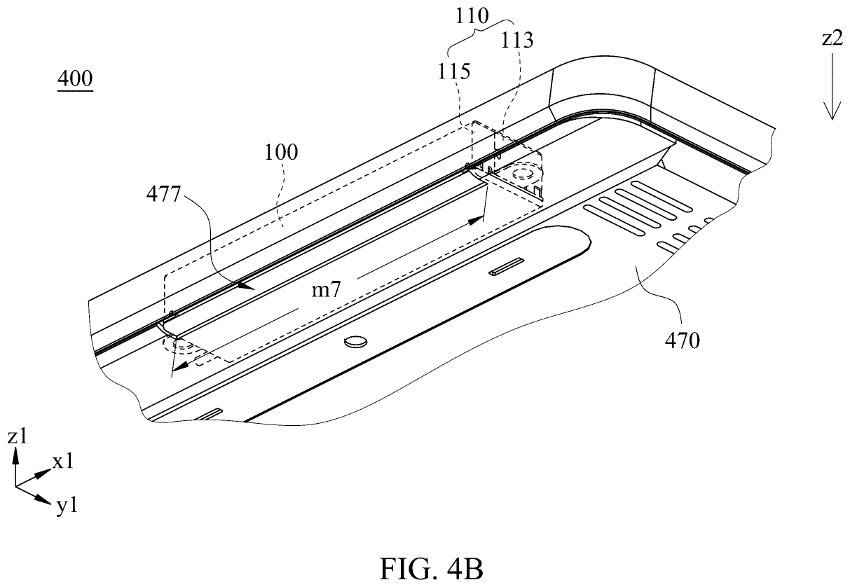

FIG. 4A is a three-dimensional view of the electronic device 400 according to a fourth embodiment of the present disclosure. Referring to FIGS. 1E and 4A, the electronic device 400 includes the cavity antenna 109 and a housing 470. Specifically, the electronic device 400 is a notebook computer (its display is not shown) and may include at least one antenna module according to the present disclosure, such as the antenna module 100 of the first embodiment and another antenna module according to the present disclosure, without limitation. The antenna module 100 and its cavity antenna 109 are disposed within the housing 470, which may be a metal or non-metal housing. As such, the circuit pattern on the circuit board 180, in combination with the metal cavity of the cavity antenna 109, enables antenna resonance functionality, and with the excellent sealing and strength characteristics of the cavity antenna 109, the electronic device 400 can meet multi-band antenna requirements.

FIG. 4B is a schematic view of a housing opening 477 of the electronic device 400 shown in FIG. 4A. Referring to FIGS. 1D, 1E, 4A, and 4B, the housing 470 may further include a housing opening 477. The bottom portion 160, the circuit board 180, and the housing opening 477 are sequentially arranged along the antenna opening direction z2. The projected areas of the bottom portion 160, the circuit board 180, and the housing opening 477 on a plane (specifically the plane defined by the first direction x1 and second direction y1 shown in FIG. 4B) at least partially overlap. The normal direction of the plane is parallel to the antenna opening direction z2. Furthermore, in embodiments of the present disclosure, the bottom portion of the cavity antenna, the circuit board, and the housing opening may be parallel or not parallel to each other. Accordingly, the antenna module 100 can be placed in a metallic environment formed by adjacent parts of the housing 470, with the housing opening 477 serving as the transmission and reception window for the antenna module 100. Compared with the conventional large-area cutout designs combining metal and plastic antennas, the antenna module 100 using the integrally formed cavity antenna 109 allows the electronic device 400 to be more aesthetically pleasing and structurally robust.

Referring to FIG. 4B, among the projected areas of the bottom portion 160, the circuit board 180, and the housing opening 477 on the plane, at least two of them may have equal lengths m7. This aids in balancing antenna performance and design convenience. Specifically, the housing opening 477 may have a length and width of 55 mm and 3.5 mm, respectively, with the length m7 being 55 mm. However, these dimensions are not limited thereto.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A cavity antenna made of a metal material, comprising:
an antenna opening;
a bottom portion disposed opposite to the antenna opening, wherein the bottom portion is rectangular in shape and comprises four bottom edges; and
four side portions respectively connected to the four bottom edges, wherein the four side portions are sequentially connected to form the cavity antenna being groove-shaped;
wherein one of the four side portions is a first side portion comprising a concave section and a convex section, and a concave edge of the concave section is coupled with a convex edge of the convex section to form the first side portion.

2. The cavity antenna of claim 1, wherein the convex edge has a dovetail shape.

3. The cavity antenna of claim 1, wherein the cavity antenna is formed by sheet metal processing of an original metal sheet.

4. The cavity antenna of claim 1, wherein at least one of the concave section and the convex section comprises a positioning structure that protrudes in an antenna opening direction.

5. The cavity antenna of claim 1, wherein another one of the four side portions is a third side portion, which is disposed opposite to the first side portion and comprises another concave section and another convex section, and a concave edge of the another concave section is coupled with a convex edge of the another convex section to form the third side portion.

6. The cavity antenna of claim 1, further comprising:
at least one folding portion connected to at least one of the four side portions, wherein the at least one folding portion is disposed opposite to the bottom portion.

7. The cavity antenna of claim 6, wherein at least one area of the at least one folding portion is between 0.01 times and 0.2 times an area of the bottom portion.

8. The cavity antenna of claim 6, wherein the four side portions have a maximum height measured from the bottom portion, and the maximum height is not located at at least one part of the at least one of the four side portions connected to the at least one folding portion.

9. The cavity antenna of claim 1, wherein the bottom portion and at least one of the four side portions are formed by bending, and a chamfer between the bottom portion and the at least one side portion ranges from 0.4T to 2T.

10. The cavity antenna of claim 1, wherein two connected side portions among the four side portions are formed by bending, and a chamfer between the two connected side portions ranges from 0.4T to 2T.

11. An antenna module, comprising:
a cavity antenna made of a metal material, comprising:
an antenna opening;
a bottom portion disposed opposite to the antenna opening, wherein the bottom portion is rectangular in shape and comprises four bottom edges; and
four side portions, wherein each of the four side portions comprises a closed edge and an opening edge, the closed edge and the opening edge are disposed opposite to each other, the four closed edges are respectively connected to the four bottom edges, and the four side portions are sequentially connected to form the cavity antenna being groove-shaped, with the four opening edges disposed adjacent to the antenna opening; and
a circuit board connected to at least one of the four opening edges and closing at least a portion of the antenna opening;
wherein one of the four side portions is a first side portion comprising a concave section and a convex section, and a concave edge of the concave section is coupled with a convex edge of the convex section to form the first side portion.

12. The antenna module of claim 11, wherein the cavity antenna further comprises a folding portion connected to one of the four side portions, and the folding portion is disposed opposite to the bottom portion and parallel to the circuit board;
wherein the folding portion accommodates a solder material, and the solder material connects the folding portion to a side surface of the circuit board.

13. The antenna module of claim 11, wherein a side surface of the circuit board comprises at least one of a metal edging region and a plated through-hole.

14. The antenna module of claim 11, further comprising:
a cable electrically connected to a circuit surface of the circuit board that faces the bottom portion of the cavity antenna.

15. The antenna module of claim 14, wherein another one of the four side portions is a fourth side portion, the opening edge of the fourth side portion is connected to a side surface of the circuit board, and the cable is disposed adjacent to the opening edge of the fourth side portion and extends parallel to the fourth side portion.

16. The antenna module of claim 11, wherein at least one of the concave section and the convex section comprises a positioning structure that protrudes in an antenna opening direction and is coupled with a recessed portion of the circuit board.

17. An electronic device, comprising:
a cavity antenna made of a metal material, comprising:
an antenna opening;
a bottom portion disposed opposite to the antenna opening, wherein the bottom portion is rectangular in shape and comprises four bottom edges; and
four side portions, wherein each of the four side portions comprises a closed edge and an opening edge, the closed edge and the opening edge are disposed opposite to each other, the four closed edges are respectively connected to the four bottom edges, and the four side portions are sequentially connected to form the cavity antenna being groove-shaped, with the four opening edges disposed adjacent to the antenna opening; and
a housing, wherein the cavity antenna is disposed within the housing;
wherein one of the four side portions is a first side portion comprising a concave section and a convex section, and a concave edge of the concave section is coupled with a convex edge of the convex section to form the first side portion.

18. The electronic device of claim 17, further comprising:
a circuit board connected to at least one of the four opening edges and closing at least a portion of the antenna opening.

19. The electronic device of claim 18, wherein the housing further comprises a housing opening, and the bottom portion, the circuit board, and the housing opening are sequentially arranged along an antenna opening direction, projected areas of the bottom portion, the circuit board, and the housing opening on a plane at least partially overlap, and a normal direction of the plane is parallel to the antenna opening direction.

20. The electronic device of claim 19, wherein at least two of the projected areas have equal lengths.
